(19) United States
(12) Patent Application Publication
(10) Pub. No.: US 2007/0006389 A1
(43) Pub. Date: Jan. 11, 2007

(54) Electrician's tool having multiple capabilities

(76) Inventor: Timothy J. Cotter, Chicago, IL (US)

Correspondence Address: WELSH & KATZ, LTD., 22nd Floor, 120 South Riverside Plaza, Chicago, IL, 60606-3945, US

(21) Appl. No.: 11/177,022

(22) Filed: Jul. 8, 2005

(51) Int. Cl. H02G 1/12; B25F 1/00

(52) U.S. Cl. 7/107; 81/9.4

(57) ABSTRACT

An electrician's tool is disclosed that incorporates the functions of wire cutting, wire stripping and wire splicing for at least one gauge of wire. The tool is used by applying pressure, in a scissor-like manner, to handles that are located on one end of the tool. The function of wire cutting is accomplished by placing a wire completely inside two cutting blades that are formed in the tool, and then by placing pressure on the handles to cut the wire. Wire stripping is accomplished by placing the cut wire on a stripping blade for that gauge of wire which is formed in the cutting blades of the tool, and then stripping the insulation off the wire. Wire splicing can then be accomplished by gripping two cut and stripped wires together, and then by rotating the gripped wires to join them together. This allows, for example, the three most common tasks that are performed by electricians to be accomplished with a single tool, thereby reducing the inefficiency and frustration of changing tools multiple times as in done in connection with prior art tools. This necessarily leads to reduced labor costs associated with having electrical work done.

### BACKGROUND OF THE INVENTION

Electricians are dependent upon certain tools in order to do their jobs. As one example, U.S. Pat. No. 6,351,865 (De Donato) discloses a tool that combines a wire cutter, stripper and punching device. Although the device includes a wire stripper and wire cutter in a single unit, a different tool is necessary for wire splicing. The content of this patent is incorporated by reference as if fully set forth herein.

Another common electrician's tool is illustrated in FIG. 1A, a wire cutter that is provided with wire stripping capabilities, tool 10. Tool 10 includes two handles 12a and 12b which move with respect to each other about a central axis 14. The handles control the movement of members 16a and 16b, both of which include a cutting edge 18a and 18b for cutting wire in a desired length. A plurality of wire stripping blades 20a and 20b are included in order for the electrician to be able to remove insulation from electrical wires.

Yet another tool that is commonly used by electricians is illustrated in FIG. 1B. Tool 22 can strip wires ad well as cut them. Tool 22 includes two handles 24a and 24b, as well as two moveable members 28a and 28b which are integral and move with handles 24a and 24b about the axis 26. Each moveable member 28a and 28b include a cutting edge 30a and 30b, as well as a gripping surface 32a and 32b, a perspective view of which is shown in FIG. 1C.

Electricians depend on these types of tools to complete the common tasks of wire cutting, wire stripping and wire splicing. For example, when wiring a house or some other building, an electrician hundreds of iterations of the following three tasks: two or more wires are cut, each wire is then stripped, and then all three wires are spliced together. For each iteration of these tasks, the electrician must use two different tools, such as the tools illustrated in FIGS. 1A and 1B. Because different tools are used, picked up, and then put down literally hundreds of times for each job, inefficiencies result. Further delays are created if the electrician accidentally drops one or both of the tools when performing each iteration of the wiring tasks.

All of these delays unnecessarily increase the labor costs in connection with having electrical work done. A need, therefore, exists for a tool which incorporates the functions of wire splitting, cutting and splicing so that an electrician will be able to complete a particular job in a smaller amount of time, which will necessarily lower the labor costs associated with having the job done that is possible with current electrician tools.

### BRIEF DESCRIPTION OF THE DRAWINGS

Various examples objects, features and attendant advantages of the present invention will become fully appreciated as the same becomes better understood when considered in conjunction with the accompanying drawings, in which like reference characters designate the same or similar parts throughout the several views, and wherein:

FIGS. 1A and 1B are side views of prior art electrician tools;

FIG. 1C is a sectional view of the tool shown in FIG. 1B taken along lines 1C-1C in FIG. 1B;

FIG. 2 is a side view of an electrical tool that is manufactured in accordance with one or more aspects of the present invention;

FIG. 3 is a close up view of a portion of the electrician's tool shown in FIG. 2;

FIG. 4 is a sectional view of the tool illustrated in FIG. 2 taken along lines 4-4 in FIG. 2;

FIGS. 5, 6, and 7A-7D illustrate how the tool shown in FIG. 2 can be used to perform wire cutting, wire splicing and wire stripping functions;

FIG. 8 shows a side view of an alternative embodiment of the present invention;

FIG. 9 shows a close-up view of a portion of the tool shown in FIG. 8; and

FIG. 10 shows a sectional view of the tool shown in FIG. 8 taken along lines 10-10 in FIG. 8.

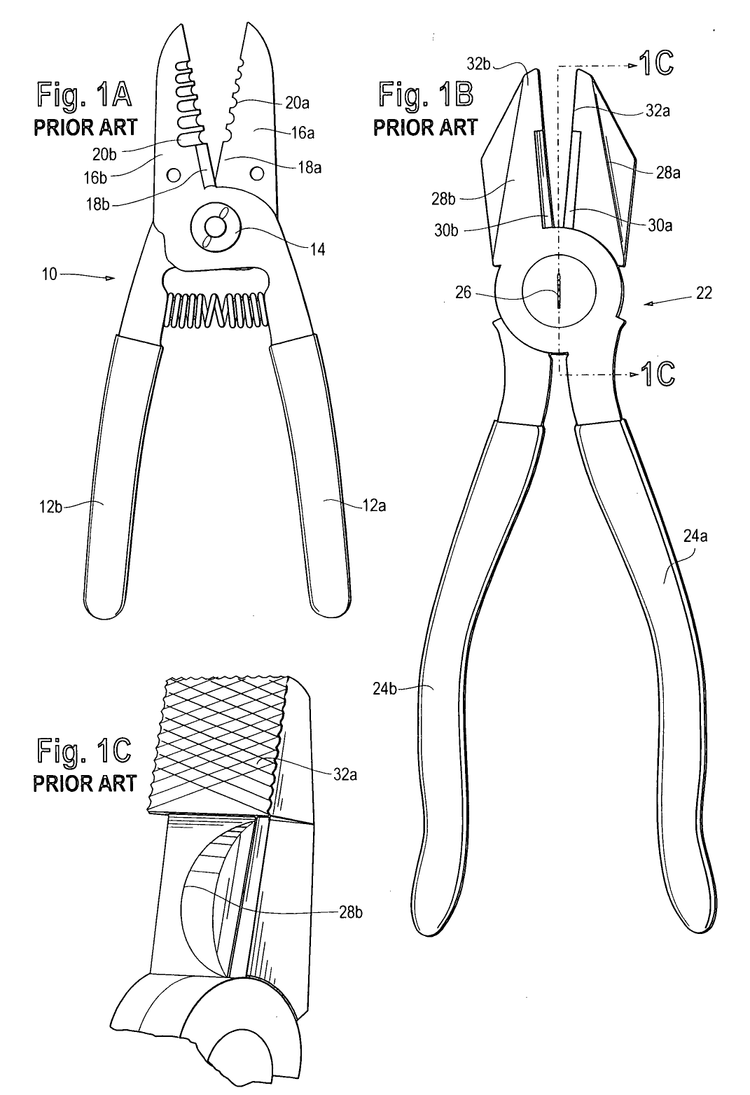

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated. It should be further understood that the title of this section of this specification, namely, “Detailed Description Of The Invention”, relates to a requirement of the United States Patent Office, and does not imply, nor should be inferred to limit the subject matter disclosed herein.

In the present disclosure, the words “a” or “an” are to be taken to include both the singular and the plural. Conversely, any reference to plural items shall, where appropriate, include the singular.

In one exemplary embodiment of the present invention, an electrician's tool is provided that incorporates the functions of wire cutting, wire stripping and wire splicing for at least one gauge of wire. The tool is used by applying pressure, in a scissor-like manner, to handles that are located on one end of the tool. The function of wire cutting is accomplished by placing a wire completely inside two cutting blades that are formed in the tool, and then by placing pressure on the handles to cut the wire. Wire stripping is accomplished by placing the cut wire on a stripping blade for that gauge of wire which is formed in the cutting blades of the tool, and then stripping the insulation off the wire. Wire splicing can then be accomplished by gripping two cut and stripped wires together, and then by rotating the gripped wires to join them together. This allows, for example, the three most common tasks that are performed by electricians to be accomplished with a single tool, thereby reducing the inefficiency and frustration of changing tools multiple times as in done in connection with prior art tools. This necessarily leads to reduced labor costs associated with having electrical work done.

In an alternative embodiment of the present invention, two wire stripper blades are formed in each cutting blade of the tool. In one exemplary application, two of the most common wire gauges for each electrical job are formed in the cutting blade. As one example, stripping blades for wires of gauge 10 and 12 can be formed in each cutting blade. Any combination of two sizes of stripping blades are within the scope of the present invention.

In accordance with both embodiments of the present invention, the tool includes two gripping surfaces that allow an electrician to grip and then join two different wires together by, for example, a twisting operation. In one exemplary embodiment, the gripping surfaces are, for example, two flat planes that are approximately 1 and ⅞ inches in length and about ½ inch in width.

In an exemplary further development of the present invention, the handles of the inventive tool can be provided with a non-conductive material such as any of a variety of polymeric materials. This allows the user to work with electrical wires while minimizing the risk of experiencing an electrical shock.

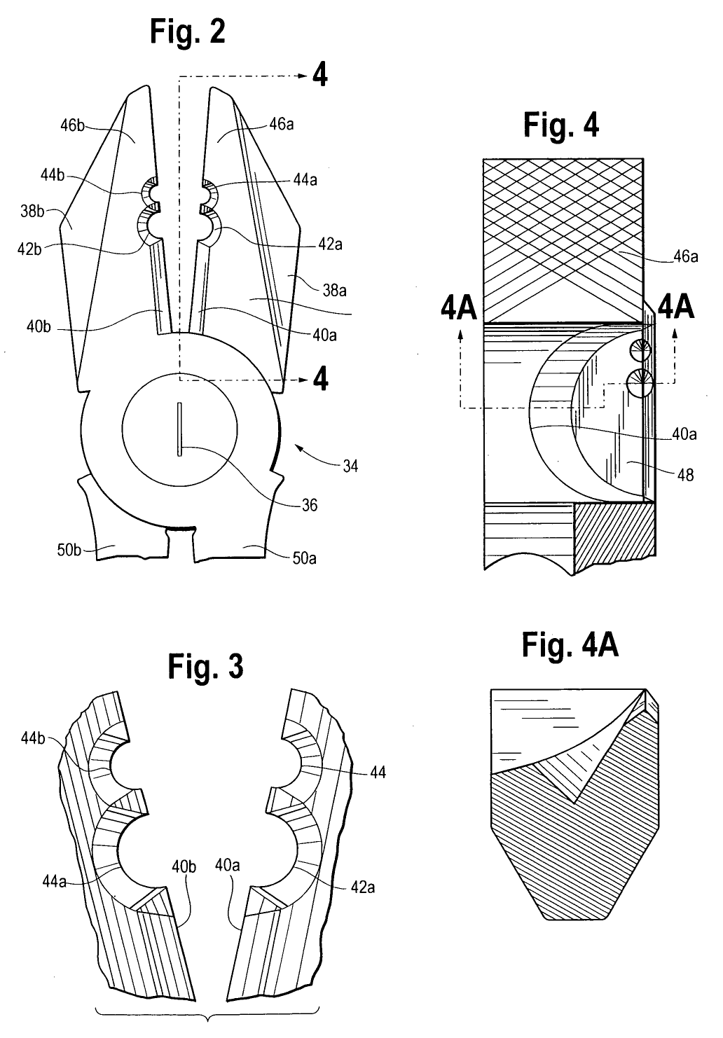

Referring specifically to FIG. 2, a side view of a portion of an electrical tool 34 that forms one exemplary one embodiment of the present invention is illustrated. Tool 34 includes two movable handles 50a and 50b which move with respect to each other about the axis 36. Tool 34 also includes two movable members 38a and 38b are integrally formed as a portion of handles 50a and 50b and, therefore, move when the handles are moved.

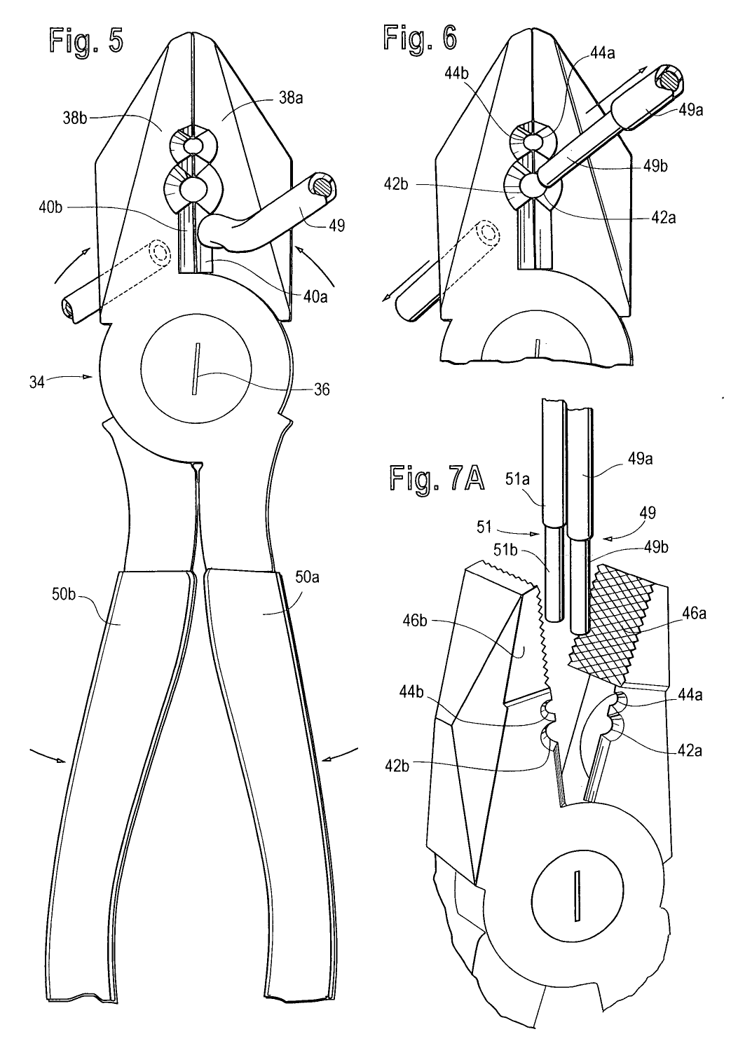

Each movable member 38a and 38b incorporates a cutting edge 40a and 40b which is used for cutting electrical wire as, for example, shown in FIG. 3. FIG. 4 is a close-up view of a portion one of the movable members, which shows how a milled out space 48 is formed therein. This allows, for example, an electrical wire to be placed onto the cutting edge of the movable member. In FIG. 5, tool 34 is being used to cut an electrical wire 49.

Again referring to FIG. 2, each movable member also includes two wire stripping blades 42a/42b and 44a/44b that are used for stripping insulation from electrical wires. FIG. 3 illustrates a close-up view of the two sets of stripping blades. In one exemplary embodiment, one pair of the stripping blades are formed to strip wire of gauge 10, and the other pair of stripping blades is formed to strip wire of gauge 12 or 14. These different gauges are chosen based on the common electrical wire used in residential and commercial buildings. By appropriately forming the size of the stripping blades in the tool 34, the number of times that an electrician will need to switch tools during each job will be reduced, thereby leading to increased labor cost savings.

In FIG. 6, an electrical wire 49 is illustrated as being stripped of insulation by tool 34. The wire stripper works so that the wire stripping blade's 42a/42b and 44a/44b diameter is smaller than the circumference of the electrical wire's conductive material 49a but not smaller than the circumference of the electrical conductive wire 49b beneath the insulation.

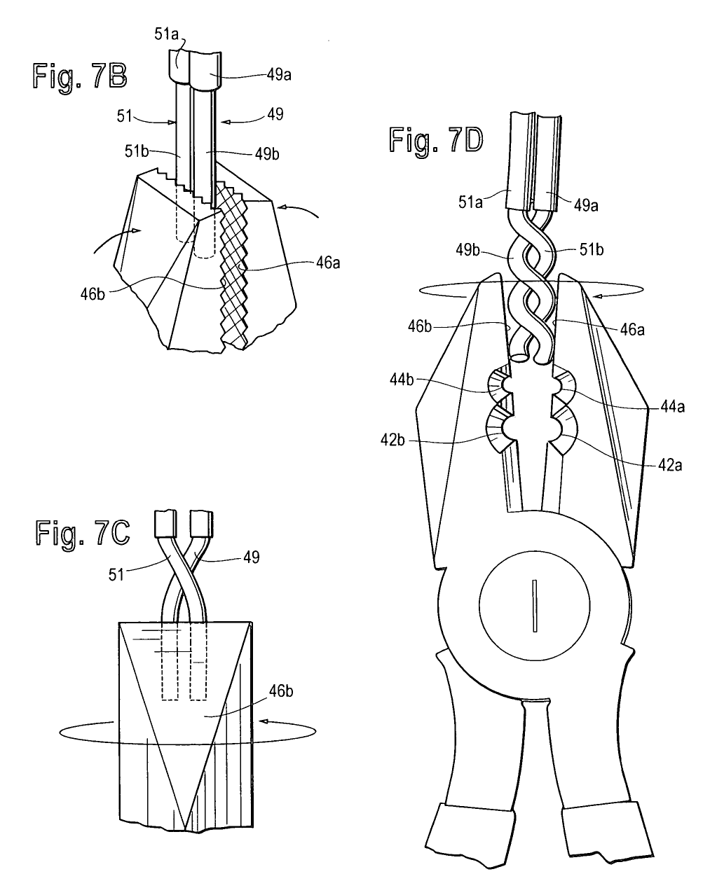

Again referring to FIG. 2, each movable member also includes two planar gripping surfaces 46a and 46b used for splicing electrical wires as, for example, shown in 7A-7D. FIG. 4 illustrates the gripping surface 46a in greater detail. FIG. 7A illustrates how two electrical wires 49 and 51 are placed by an electrician between the gripping surfaces 46a and 46b. The gripping surfaces 46a and 46b are used to grip the conductive ends 49a and 51a of the electrical wire. FIG. 7B demonstrates the gripping surfaces 46a and 46b gripping the two electrical wires 49 and 51 after the movable handles 50a and 50b are closed by the electrician. FIG. 7C illustrates the twisting (or splicing) of the two electrical wires 49 and 51. FIG. 7D completes the cycle, illustrating two spliced electrical wires 49 and 51.

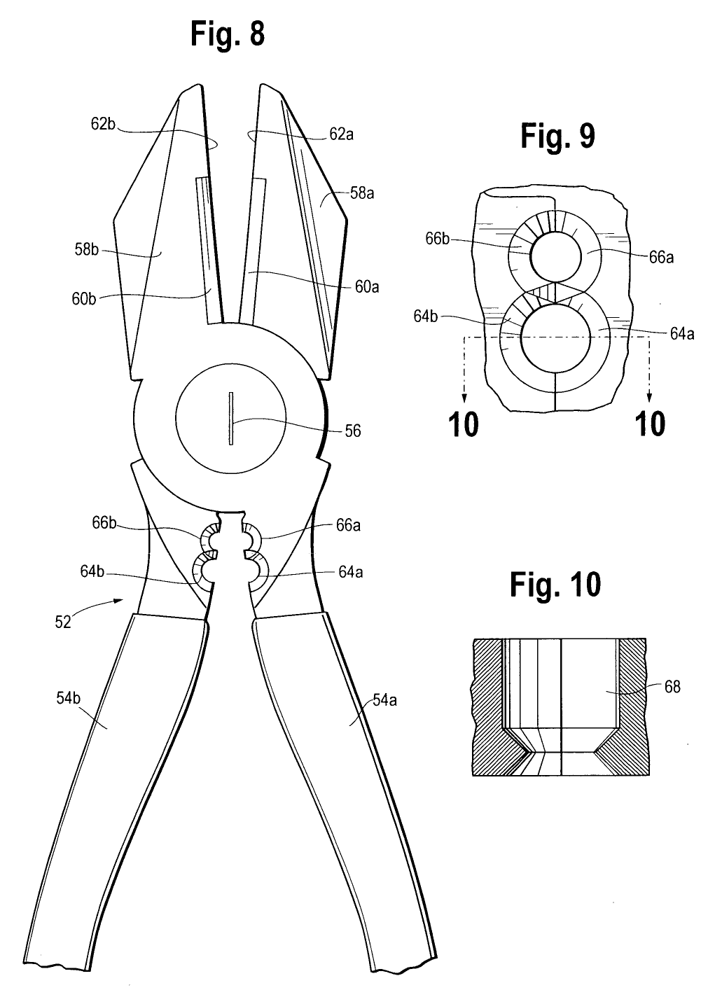

An alternative embodiment of the present invention is illustrated in FIG. 8. In accordance with this embodiment of the present invention, the stripping blades do not have to be formed in the cutting blade of the tool. Rather, tool 52 has two handles 54a and 54b which move with respect to each other about an axis 56, includes two movable members 58a and 58b which are integrally formed as a portion of and, therefore, move with respect to each handle, a cutting edge 60a and 60b used for cutting electrical wire, and gripping surfaces 62a and 62b.

In contrast to the first embodiment of the invention discussed previously, in tool 52, the wire stripper blades are placed in the handles as opposed to being formed in the cutting blades of the tool that are on the opposite ends of the handle. FIG. 9 depicts a closer view of tool 52's wire strippers in a closed position. Referring to FIG. 10 an electrical wire 68 is shown between a wire stripping blade of tool 52. The wire stripping blade is engaging the electrical wire's 68 insulation at point 70.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A tool, comprising:
a main body, having a first and second end, the first end being divided into two separate components, and the second end having two complementary structures with two sides and two ends for receiving electrical wires;
a wire blade located on each one of the of the complementary structures;
a wire stripping blade that is formed in each one of the complementary structures; and
wherein the first and second ends are connected by a planar portion having rotating capabilities.

2. The tool of claim 1, wherein the main body is two mirror image pieces.

3. The tool of claim 2, wherein the upper rotating means holds the two mirror image pieces together.

4. The tool as in claim 1, wherein the series of wire stripping apparatus consists of two gauges.

5. The tool as in claim 4, wherein the first gauge is a 12 and the second gauge is a 10.

6. The tool as in claim 4, wherein the first gauge is a 12 and the second gauge is a 14.

7. The tool as in claim 1, wherein the first end of the main body is a pair of handles.

8. The tool as in claim 7, wherein the pair of handles is comprised of non-conductive material.

9. The tool as in claim 1, wherein the means for twisting wires is a pair of flat planes.

10. The tool as in claim 9, wherein the pair of flat planes are no shorter than 1 and ⅞ inches.

11. The tool as in claim 10, wherein the pair of flat planes have a width of at least ½ inch.
